(19) United States
(12) Patent Application Publication
(10) Pub. No.: US 2009/0278794 A1
(43) Pub. Date: Nov. 12, 2009

(54) Interactive Input System With Controlled Lighting

(75) Inventors: Daniel P. McReynolds, Calgary (CA); Gerald Morrison, Calgary (CA); Grant McGibney, Calgary (CA)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: SMART TECHNOLOGIES ULC, Calgary (CA)

(21) Appl. No.: 12/118,521

(22) Filed: May 9, 2008

(51) Int. Cl. G09G 5/00

(52) U.S. Cl. 345/156

(57) ABSTRACT

An interactive input system comprises at least one imaging device capturing images of a region of interest, a plurality of radiation sources, each providing illumination to the region of interest and a controller coordinating the operation of the radiation sources and the at least one imaging device to allow separate image frames based on contributions from different radiation sources to be generated.

### FIELD OF THE INVENTION

The present invention relates generally to interactive input systems and in particular, to an interactive input system with controlled lighting.

### BACKGROUND OF THE INVENTION

Interactive input systems that allow users to input ink into an application program using an active pointer (eg. a pointer that emits light, sound or other signal), a passive pointer (eg. a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 assigned to SMART Technologies ULC of Calgary, Alberta, Canada, assignee of the subject application, the contents of which are incorporated by reference; touch systems comprising touch panels employing electromagnetic, capacitive, acoustic or other technologies to register pointer input; tablet personal computers (PCs); laptop PCs; personal digital assistants (PDAs); and other similar devices.

In order to facilitate the detection of pointers relative to a touch surface in interactive input systems, various lighting schemes have been considered. For example, U.S. Pat. No. 4,243,879 to Carroll et al. discloses a dynamic level shifter for photoelectric touch panels incorporating a plurality of photoelectric transducers. The dynamic level shifter periodically senses the ambient light level immediately before the interval when each photoelectric transducer can receive a pulse of radiant energy during normal operation of the touch panel. The output of each photoelectric transducer during such an interval is compared with the output during the previous ambient interval in order to develop a signal indicative of the presence or absence of the radiant energy pulse, irrespective of ambient light fluctuations.

U.S. Pat. No. 4,893,120 to Doering et al. discloses a touch panel system that makes use of modulated light beams to detect when one or more of the light beams are blocked even in bright ambient light conditions. The touch panel system comprises a touch sensitive display surface with a defined perimeter. Surrounding the display surface is a multiplicity of light emitting elements and light receiving elements. The light emitting and light receiving elements are located so that the light paths defined by selected pairs of light emitting and light receiving elements cross the display surface and define a grid of intersecting light paths. A scanning circuit sequentially enables selected pairs of light emitting and light receiving elements, modulating the amplitude of the light emitted in accordance with a predetermined pattern. A filter generates a blocked path signal if the currently enabled light receiving element is not generating an output signal that is modulated in accordance with the predetermined pattern. If the filter is generating at least two blocked path signals corresponding to light paths which intersect one another within the perimeter of the display surface, a computer determines if an object is adjacent to the display surface, and if so, the location of the object.

U.S. Pat. No. 6,346,966 to Toh discloses an image acquisition system that allows different lighting techniques to be applied to a scene containing an object of interest concurrently. Within a single position, multiple images which are illuminated by different lighting techniques are acquired by selecting specific wavelength bands for acquiring each of the images. In a typical application, both back lighting and front lighting are simultaneously used to illuminate an object, and different image analysis methods are applied to the acquired images.

U.S. Pat. No. 6,498,602 to Ogawa discloses an optical digitizer that recognizes pointer instruments thereby to allow input to be made using a finger or pointer. The optical digitizer comprises a light source to emit a light ray, an image taking device which is arranged in a periphery of a coordinate plane, and which converts an image of the pointing instrument into an electrical signal after taking an image of the pointing instrument and a computing device to compute the pointing position coordinates after processing the converted electrical signal by the image taking device. A polarizing device polarizes the light ray emitted by the light source into a first polarized light ray or a second polarized light ray. A switching device switches the irradiating light on the coordinate plane to the first polarized light or the second polarized light. A retroreflective material with retroreflective characteristics is installed at a frame of the coordinate plane. A polarizing film with a transmitting axis causes the first polarized light ray to be transmitted. A judging device judges the pointing instrument as the first pointing instrument when the image of the pointing instrument is taken by the first polarized light ray, and judges the pointing instrument as the second pointing instrument when the image of the pointing instrument is taken by the second polarized light ray.

U.S. Patent Application Publication No. 2003/0161524 to King discloses a method and system to improve the ability of a machine vision system to distinguish the desired features of a target by taking images of the target under one or more different lighting conditions, and using image analysis to extract information of interest about the target. Ultraviolet light is used alone or in connection with direct on-axis and/or low angle lighting to highlight different features of the target. One or more filters disposed between the target and a camera help to filter out unwanted light from the one or more images taken by the camera. The images may be analyzed by conventional image analysis techniques and the results recorded or displayed on a computer display device.

U.S. Patent Application Publication No. 2005/0248540 to Newton discloses a touch panel that has a front surface, a rear surface, a plurality of edges, and an interior volume. An energy source is positioned in proximity to a first edge of the touch panel and is configured to emit energy that is propagated within the interior volume of the touch panel. A diffusing reflector is positioned in proximity to the front surface of the touch panel for diffusively reflecting at least a portion of the energy that escapes from the interior volume. At least one detector is positioned in proximity to the first edge of the touch panel and is configured to detect intensity levels of the energy that is diffusively reflected across the front surface of the touch panel. Two spaced apart detectors in proximity to the first edge of the touch panel allow calculation of touch locations using simple triangulation techniques.

U.S. Patent Application Publication No. 2006/0170658 to Nakamura et al. discloses an edge detection circuit to detect edges in an image in order to enhance both the accuracy of determining whether an object has contacted a screen and the accuracy of calculating the coordinate position of the object. A contact determination circuit determines whether or not the object has contacted the screen. A calibration circuit controls the sensitivity of optical sensors in response to external light, whereby a drive condition of the optical sensors is changed based on the output values of the optical sensors.

Although the above references discloses systems that employ lighting techniques, improvements in lighting techniques to enhance detection of user input in an interactive input system are desired. It is therefore an object of the present invention to provide a novel interactive input system with controlled lighting.

### SUMMARY OF THE INVENTION

Accordingly, in one aspect there is provided an interactive input system comprising at least one imaging device capturing images of a region of interest, a plurality of radiation sources, each providing illumination to the region of interest and a controller coordinating the operation of the radiation sources and the at least one imaging device to allow separate image frames based on contributions from different radiation sources to be generated.

In one embodiment, each radiation source is switched on and off according to a distinct switching pattern. The distinct switching patterns and imaging device frame rate are selected to eliminate substantially effects from ambient light and flickering light sources. The distinct switching patterns are substantially orthogonal and may follow Walsh codes.

According to another aspect there is provided an interactive input system comprising at least two imaging devices capturing overlapping images of a region of interest from different vantages, a radiation source associated with each imaging device to provide illumination into the region of interest, a controller timing the frame rates of the imaging devices with distinct switching patterns assigned to the radiation sources and demodulating captured image frames to generate image frames based on contributions from different radiation sources and processing structure processing the separated image frames to determine the location of a pointer within the region of interest.

According to yet another aspect there is provided a method of generating image frames in an interactive input system comprising at least one imaging device capturing images of a region of interest and multiple radiation sources providing illumination into the region of interest, said method comprising turning each radiation source on and off according to a distinct pattern, the patterns being generally orthogonal, synchronizing the frame rate of the imaging device with the distinct patterns and demodulating the captured image frames to yield image frames based on contributions from different radiation sources.

According to still yet another aspect there is provided in an interactive input system comprising at least one imaging device capturing images of a region of interest and multiple radiation sources providing illumination into the region of interest, an imaging method comprising modulating the output of the radiation sources, synchronizing the frame rate of the imaging device with the modulated radiation source output and demodulating captured image frames to yield image frames based on contributions from different radiation sources.

### BRIEF DESCRIPTION OF THE DRAWINGS

Embodiments will now be described more fully with reference to the accompanying drawings in which:

FIG. 1 is a perspective view of an interactive input system with controlled lighting;

FIG. 2 is a block diagram view of the interactive input system of FIG. 1;

FIG. 3 is a perspective conceptual view of a portion of the interactive input system of FIG. 1;

FIG. 4 is a schematic diagram of a portion of the interactive input system of FIG. 1;

FIG. 5 shows the on/off timing patterns of image sensors and infrared light sources during subframe capture.

FIG. 6 is a schematic diagram showing the generation of image frames by combining different image subframes;

FIG. 7 is a schematic diagram of a modulated lighting controller shown in FIG. 4;

FIG. 8 is a schematic diagram of a subframe controller forming part of the modulated lighting controller of FIG. 7;

FIG. 9 is a schematic diagram of a demodulator forming part of the modulated lighting controller of FIG. 7;

FIG. 10 is a schematic diagram of a light output interface forming part of the modulated lighting controller of FIG. 7.

### DETAILED DESCRIPTION OF THE EMBODIMENTS

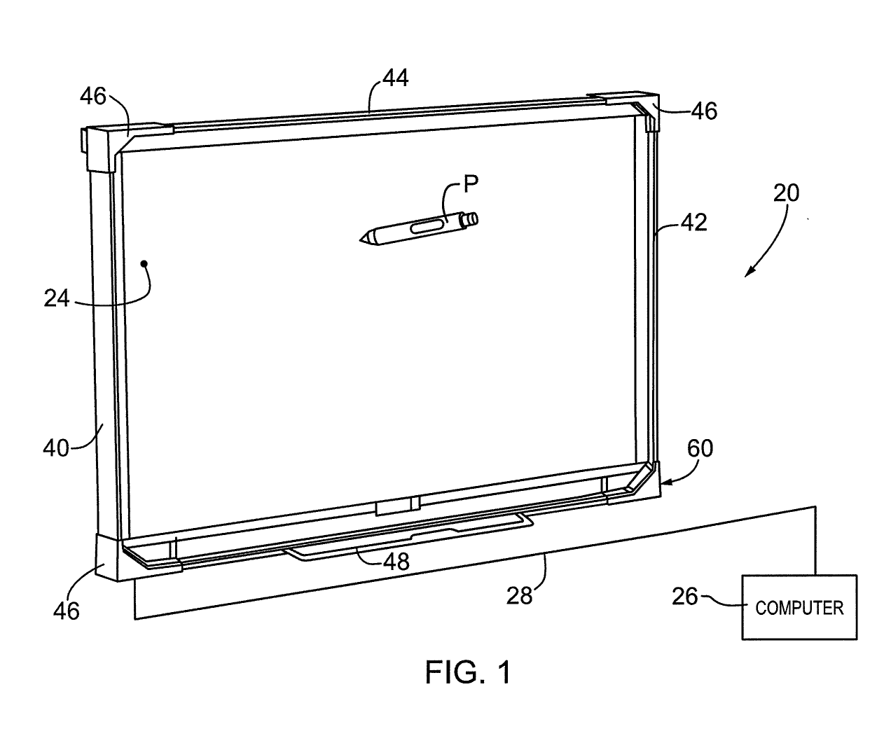

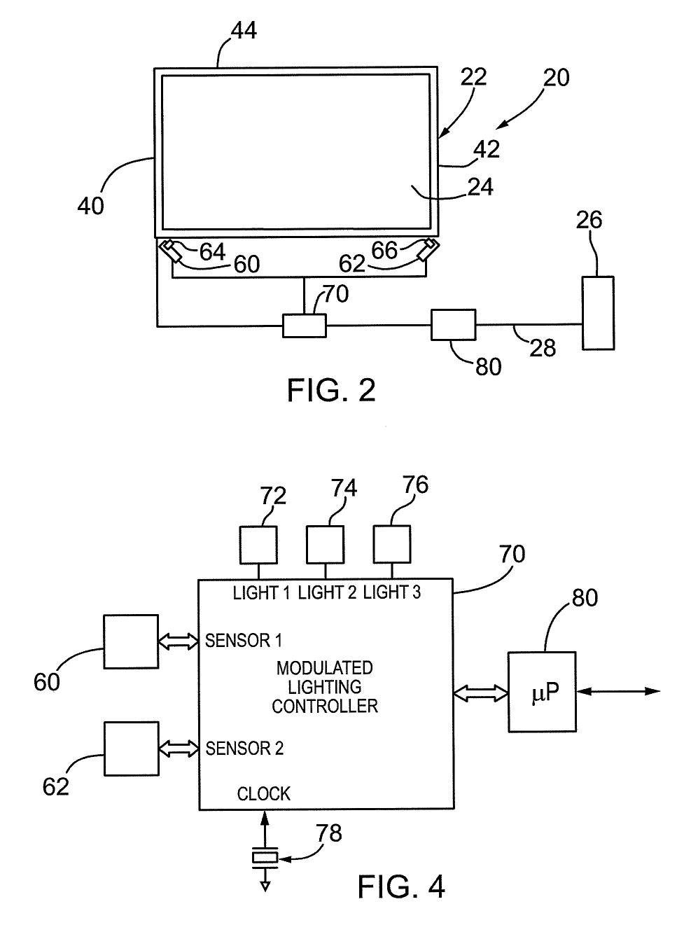

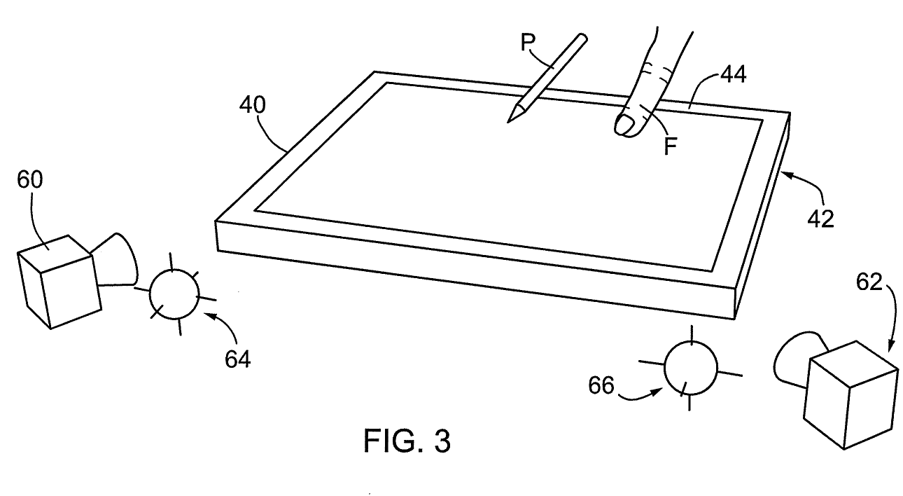

Turning now to FIGS. 1 to 4, an interactive input system that allows a user to input ink into an application program is shown and is generally identified by reference numeral 20. In this embodiment, interactive input system 20 comprises an assembly 22 that engages a display unit (not shown) such as for example, a plasma television, a liquid crystal display (LCD) device, a flat panel display device, a cathode ray tube etc. and surrounds the display surface 24 of the display unit. The assembly 22 employs machine vision to detect pointers brought into proximity with the display surface 24 and communicates with a computer 26 executing one or more application programs via a universal serial bus (USB) cable 28. Computer 26 processes the output of the assembly 22 and adjusts image data that is output to the display unit so that the image presented on the display surface 24 reflects pointer activity. In this manner, the assembly 22 and computer 26 form a closed loop allowing pointer activity proximate the display surface 24 to be recorded as writing or drawing or used to control execution of one or more application programs executed by the computer 26.

Assembly 22 comprises a frame assembly that is attached to the display unit and surrounds the display surface 24. Frame assembly comprises a bezel having three illuminated bezel segments 40 to 44, four corner pieces 46 and a tool tray segment 48. Bezel segments 40 and 42 extend along opposite side edges of the display surface 24 while bezel segment 44 extends along the top edge of the display surface 24. The illuminated bezel segments 40 to 44 form an infrared (IR) light source about the display surface periphery that can be conditioned to emit infrared illumination so that a pointer positioned within the region of interest adjacent the display surface 24 is backlit by the emitted infrared radiation. The bezel segments 40 to 44 may be of the type disclosed in U.S. Pat. No. 6,972,401 to Akitt et al. and assigned to SMART Technologies ULC of Calgary, Alberta, Canada, assignee of the subject application, the content of which is incorporated by reference The tool tray segment 48 extends along the bottom edge of the display surface 24 and supports one or more pen tools P. The corner pieces 46 adjacent the top left and top right corners of the display surface 24 couple the bezel segments 40 and 42 to the bezel segment 44. The corner pieces 46 adjacent the bottom left and bottom right corners of the display surface 24 couple the bezel segments 40 and 42 to the tool tray segment 48.

In this embodiment, the corner pieces 46 adjacent the bottom left and bottom right corners of the display surface 24 accommodate image sensors 60 and 62 that look generally across the entire display surface 24 from different vantages. The image sensors 60 and 62 are of the type manufactured by Micron under model No. MT9V023 and are fitted with an 880 nm lens of the type manufactured by Boowon under model No. BW25B giving the image sensors a 98 degree field of view. Of course, those of skill in the art will appreciate that other commercial or custom image sensors may be employed. Each corner piece 46 adjacent the bottom left and bottom right corners of the display surface 24 also accommodates an IR light source 64, 66 that is positioned proximate to its associated image sensor. The IR light sources 64 and 66 can be conditioned to emit infrared illumination so that a pointer positioned within the region of interest is front lit by the emitted infrared radiation.

The image sensors 60 and 62 communicate with a modulated lighting controller 70 that controls operation of the illuminated bezel segments 40 to 44 and the IR light sources 64 and 66 via light control circuits 72 to 76. Each light control circuit 72 to 76 comprises a power transistor and a ballast resistor. Light control circuit 72 is associated with the illuminated bezel segments 40 to 44, light control circuit 74 is associated with IR light source 64 and light control circuit 76 is associated with IR light source 66. The power transistors and ballast resistors of the light control circuits 72 to 76 act between their associated IR light source and a power source. The modulated lighting controller 70 receives clock input from a crystal oscillator 78 and communicates with a microprocessor 80. The microprocessor 80 also communicates with the computer 26 over the USB cable 28.

The modulated lighting controller 70 is preferably implemented on an integrated circuit such as for example a field programmable gate array (FPGA) or application specific integrated circuit (ASIC). Alternatively, the modulated lighting controller 70 may be implemented on a generic digital signal processing (DSP) chip or other suitable processor.

The interactive input system 20 is designed to detect a passive pointer such as for example, a user's finger F, a cylinder or other suitable object as well as a pen tool P having a retro-reflective or highly reflective tip, that is brought into proximity with the display surface 24 and within the fields of view of the image sensors 60 and 62. In general, during operation, the illuminated bezel segments 40 to 44, the IR light source 64 and the IR light source 66 are each turned on and off (i.e. modulated) by the modulated lighting controller 70 in a distinct pattern. The on/off switching patterns are selected so that the switching patterns are generally orthogonal. As a result, if one switching pattern is cross-correlated with another switching pattern, the result is substantially zero and if a switching pattern is cross-correlated with itself, the result is a positive gain. This allows image frames to be captured by the image sensors 60 and 62 with the illuminated bezel segments 40 to 44 and the IR light sources 64 and 66 simultaneously active and the image frames processed to yield separate image frames that only include contributions from a selected one of the IR light sources.

In this embodiment, the orthogonal properties of Walsh codes such as those used in code division multiple access (CDMA) communication systems are employed to modulate the illuminated bezel segments 40 to 44 and IR light sources 64 and 66 thereby to allow the image contributions of different light sources to be separated. For example, Walsh codes W₁={1, −1, 1, −1, 1, −1, 1, −1,} and W₂={1, 1, −1, −1, 1, 1, −1, −1} are orthogonal meaning that when corresponding elements are multiplied together and summed, the result is zero. As will be appreciated, light sources cannot take on negative intensities. The illuminated bezel segments 40 to 44, the IR light source 64 and the IR light source 66 are therefore each turned on and off by the modulated lighting controller 70 according to a distinct modified Walsh code MWₓ, where a Walsh code bit of value one (1) signifies an on condition and a Walsh code bit of value zero (0) signifies an off condition. In particular, the illuminated bezel segments 40 to 44 are turned on and off following modified Walsh code MW₁={1, 0, 1, 0, 1, 0, 1, 0}. IR light source 64 is turned on and off following modified Walsh code MW₂={1, 1, 0, 0, 1, 1, 0, 0}. IR light source 66 is turned on and off following Walsh modified code MW₃={1, 0, 0, 1, 1, 0, 0, 1}. As will be appreciated, replacing the negative Walsh code bit values with zero values introduces a dc bias to the IR lighting.

During demodulation, the Walsh codes W₁={1, −1, 1, −1, 1, −1, 1, −1}, W₂={1, 1, −1, −1, 1, 1, −1, −1} and W₃={1, −1, −1, 1, 1, −1, −1, 1} are employed. These Walsh codes are of interest as they have spectral nulls at dc, 120 Hz, 240 Hz and 360 Hz at a subframe rate of 960 Hz. As a result, if these Walsh codes are cross-correlated, frequencies at dc, 120 Hz, 240 Hz and 360 Hz are eliminated allowing the effects of external steady state light (eg. sunlight), the dc bias introduced by the modified Walsh codes MWₓ and the effects of light sources (eg. fluorescent and incandescent light sources etc.) that flicker at common frequencies i.e. 120 Hz in North America to be filtered out. If the interactive input system 20 is used in different environments where lighting flickers at a different frequency, the subframe rate is adjusted to filter out the effects of this flickering light.

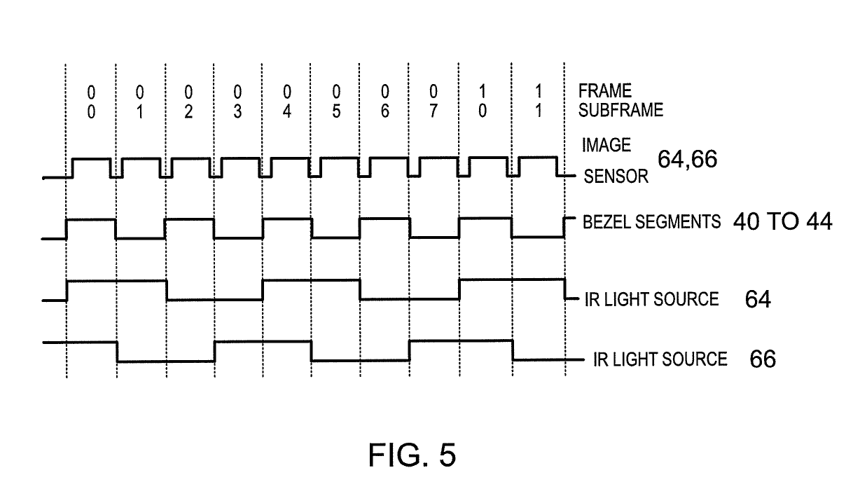

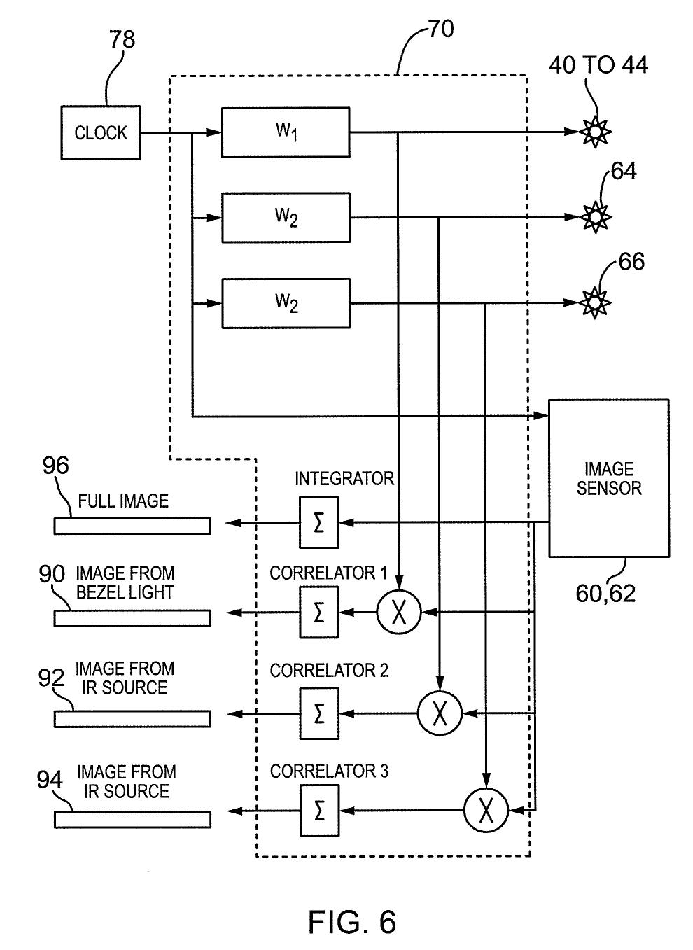

The image sensors 60 and 62 are operated by the modulated lighting controller 70 synchronously with the on/off switching patterns of the illuminated bezel segments 40 to 44, the IR light source 64 and the IR light source 66 so that eight (8) subframes at the subframe rate of 960 frames per second (fps) are captured giving each image sensor a 120 Hz frame rate. FIG. 5 shows the on/off switching patterns of the IR light sources and the subframe capture rate of the image sensors 60 and 62. The subframes captured by the image sensors 60 and 62 are combined by the modulated lighting controller 70 in different combinations to yield a plurality of resultant image frames, namely an image frame 90 from each image sensor 60, 62 based substantially only on the contribution of the infrared illumination emitted by the illuminated bezel segments 40 to 44, an image frame 92 from image sensor 60 based substantially only on the contribution of the infrared illumination emitted by the IR light source 64, an image frame 94 from image sensor 62 based substantially only on the contribution of the infrared illumination emitted by the IR light source 66 and an image frame 96 from each image sensor 60, 62 based on the contribution of the infrared illumination emitted by the illuminated bezel segments 40 to 44, the IR light source 64, the IR light source 66 and ambient light as shown in FIG. 6.

The resultant image frames generated by the modulated lighting controller 70 are then conveyed to the microprocessor 80. Upon receipt of the image frames, the microprocessor 80 examines the image frames based substantially only on the contribution of the infrared illumination emitted by the illuminated bezel segments 40 to 44 generated for each image sensor 60, 62 to detect the presence of a pointer. For these image frames, the illuminated bezel segments 40 to 44 appear as a bright band in the image frames. If a pointer is in proximity with the display surface 24 during capture of the subframes, the pointer will occlude the backlight infrared illumination emitted by the illuminated bezel segments 40 to 44. As a result, the pointer will appear in each image frame as a dark region interrupting the bright band.

The microprocessor 80 processes successive image frames output by each image sensor 60, 62 in pairs. When a pair of image frames from an image sensor is available, the microprocessor 80 subtracts the image frames to form a difference image frame and then processes the difference image frame to generate discontinuity values representing the likelihood that a pointer exists in the difference image frame. When no pointer is proximity with the display surface 24, the discontinuity values are high. When a pointer is in proximity with the display surface 24, some of the discontinuity values fall below a threshold value allowing the existence of the pointer in the difference image frame to be readily determined.

In order to generate the discontinuity values for each difference image frame, the microprocessor 80 calculates a vertical intensity profile (VIP_{bezel}) for the image frame by summing the intensity values of the pixels in each pixel column of the image frame. If no pointer exists, the VIP_{bezel} values will remain high for all of the pixel columns of the image frame. However, if a pointer is present in the image frame, the VIP_{bezel} values will drop to low values at a region corresponding to the location of the pointer in the image frame. The resultant VIP_{bezel} curve defined by the VIP_{bezel} values for each image frame is examined to determine if the VIP_{bezel} curve falls below a threshold value signifying the existence of a pointer and if so, to detect the left and right edges in the VIP_{bezel} curve that represent opposite sides of a pointer.

In particular, in order to locate left and right edges in each image frame, the first derivative of the VIP_{bezel} curve is computed to form a gradient curve ∇ VIP_{bezel}(x). If the VIP_{bezel} curve drops below the threshold value signifying the existence of a pointer, the resultant gradient curve ∇ VIP_{bezel}(x) will include a region bounded by a positive peak and a negative peak representing the edges formed by the dip in the VIP_{bezel} curve. In order to detect the peaks and hence the boundaries of the region, the gradient curve ∇ VIP_{bezel}(x) is subjected to an edge detector.

In particular, a threshold T is first applied to the gradient curve ∇ VIP_{bezel}(x) so that, for each position x, if the absolute value of the gradient curve ∇ D(x) is less than the threshold, that value of the gradient curve ∇ VIP_{bezel}(x) is set to zero as expressed by:

∇ VIP_{bezel}(x)=0, if |∇ VIP_{bezel}(x)|<T

Following the thresholding procedure, the thresholded gradient curve ∇ VIP_{bezel}(x) contains a negative spike and a positive spike corresponding to the left edge and the right edge representing the opposite sides of the pointer, and is zero elsewhere. The left and right edges, respectively, are then detected from the two non-zero spikes of the thresholded gradient curve ∇ VIP_{bezel}(x). To calculate the left edge, the centroid distance CD_{left} is calculated from the left spike of the thresholded gradient curve ∇ VIP_{bezel}(x) starting from the pixel column X_{left} according to:

$${CD}_{left} = \frac{{\sum }_{i} ( {x}_{i} - {X}_{left} ) ∇ {VIP}_{bezel} ( {x}_{i} )}{{\sum }_{i} ∇ {VIP}_{bezel} ( {x}_{i} )}$$

where xᵢ is the pixel column number of the i-th pixel column in the left spike of the gradient curve ∇ VIP_{bezel}(x), i is iterated from 1 to the width of the left spike of the thresholded gradient curve ∇ VIP_{bezel}(x) and X_{left} is the pixel column associated with a value along the gradient curve ∇ VIP_{bezel}(x) whose value differs from zero (0) by a threshold value determined empirically based in system noise. The left edge in the thresholded gradient curve ∇ VIP_{bezel}(x) is then determined to be equal to X_{left}+CD_{left}.

To calculate the right edge, the centroid distance CD_{right} is calculated from the right spike of the thresholded gradient curve ∇ VIP_{bezel}(x) starting from the pixel column X_{right} according to:

$${CD}_{right} = \frac{{\sum }_{j} ( {x}_{i} - {X}_{right} ) {VIP}_{bezel} ( {x}_{j} )}{{\sum }_{j} ∇ {VIP}_{bezel} ( {x}_{j} )}$$

where xⱼ is the pixel column number of the j-th pixel column in the right spike of the thresholded gradient curve ∇ VIP_{bezel}(x), j is iterated from 1 to the width of the right spike of the thresholded gradient curve ∇ VIP_{bezel}(x) and X_{right} is the pixel column associated with a value along the gradient curve ∇ VIP_{bezel}(x) whose value differs from zero (0) by a threshold value determined empirically based on system noise. The right edge in the thresholded gradient curve is then determined to be equal to X_{right}+CD_{right}.

Once the left and right edges of the thresholded gradient curve ∇ VIP_{bezel}(x) are calculated, the midpoint between the identified left and right edges is then calculated thereby to determine the location of the pointer in the difference image frame.

If a pointer is detected in the image frames based substantially only on the contribution of the infrared illumination emitted by the illuminated bezels 40 to 44, image frames based substantially only on the contribution of infrared illumination emitted by the IR light source 64 and image frames based substantially only on the contribution of infrared illumination emitted by the IR light source 66 are processed to determine if the pointer is a pen tool P. As will be appreciated, if the pointer is a pen tool P, the pen tool P will appear as a bright region on a dark background in the image frames captured by each image sensor due to the reflection of emitted infrared illumination by the retro-reflective pen tool tip back towards the IR light sources and hence, towards the image sensors 60 and 62. If the pointer is a finger F, then the pointer will appear substantially darker in at least one of these image frames.

If the existence of a pen tool P is determined, the image frames, are processed in the same manner described above in order to determine the location of the pen tool P in the image frames.

After the location of the pointer in the image frames has been determined, the microprocessor 80 uses the pointer positions in the image frames to calculate the position of the pointer in (x,y) coordinates relative to the display surface 24 using triangulation in a manner similar to that described in above-incorporated U.S. Pat. No. 6,803,906 to Morrison et al. The calculated pointer coordinate is then conveyed by the microprocessor 80 to the computer 26 via the USB cable 28. The computer 26 in turn processes the received pointer coordinate and updates the image output provided to the display unit, if required, so that the image presented on the display surface 24 reflects the pointer activity. In this manner, pointer interaction with the display surface 24 can be recorded as writing or drawing or used to control execution of one or more application programs running on the computer 26.

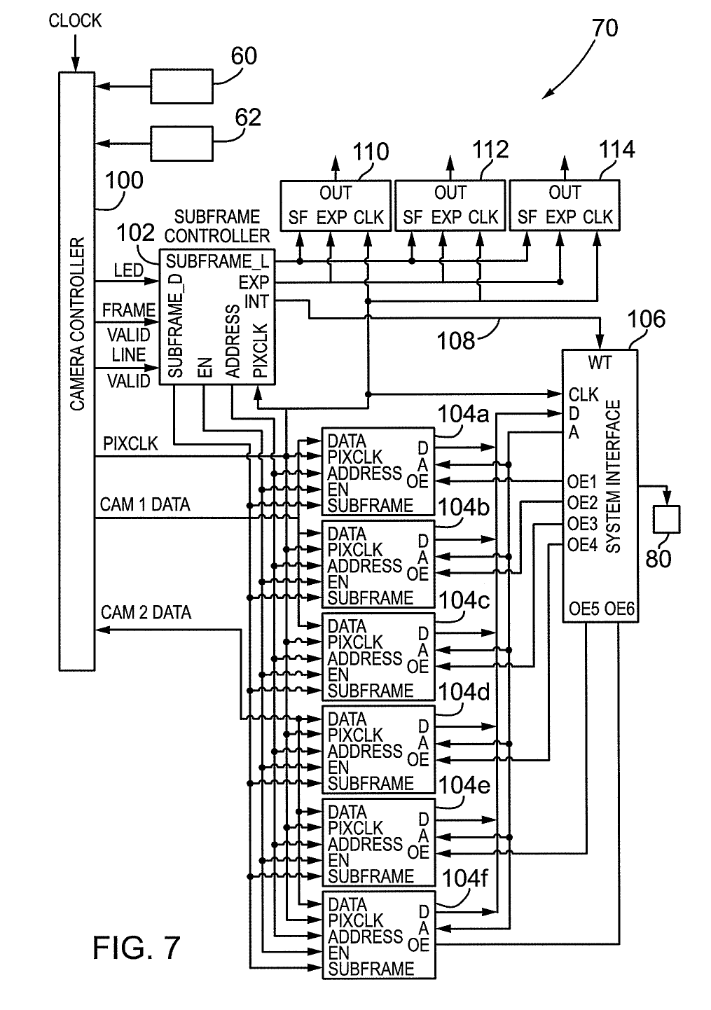

The components of the modulated lighting controller 70 and its operation will now be described with particular reference to FIGS. 7 to 10. Turning now to FIG. 7, the modulated lighting controller 70 is better illustrated. As can be seen, the modulated lighting controller 70 comprises an image sensor controller 100 that receives the clock signals output by the crystal oscillator 78. The image sensor controller 100 provides timing signals to the image sensors 60 and 62 to set the image sensor subframe rates and is connected to a subframe controller 102 via PIXCLK, LED, Frame_Valid and Line_Valid signal lines. The image sensor controller 100 also communicates with a plurality of demodulators, in this case six (6) demodulators 104a to 104f. In particular, the image sensor controller 100 is connected to demodulators 104a to 104c via a CAM1DATA line and is connected to demodulators 104d to 104f via a CAM2DATA line. The image sensor controller 100 is also connected to the demodulators 104a to 104f via the PIXCLK signal line. The demodulators 104a to 104f are connected to an output interface 106 via D, A and OEₓ signal lines. The output interface 106 is also connected to the subframe controller 102 via line 108, to the image sensor controller 100 via the PIXCLK signal line and to the microprocessor 80.

The subframe controller 102 is connected to each of the demodulators 104a to 104f via subframe_D, EN and address signal lines. The subframe controller 102 is also connected to each of the light control interfaces 110 to 114 via subframe_L and EXP signal lines. The light control interfaces 110 to 114 are also connected to the PIXCLK signal line. Light control interface 110 is connected to the light control circuit 72, light control interface 112 is connected to the light control circuit 74 and light control interface 114 is connected to light control circuit 76.

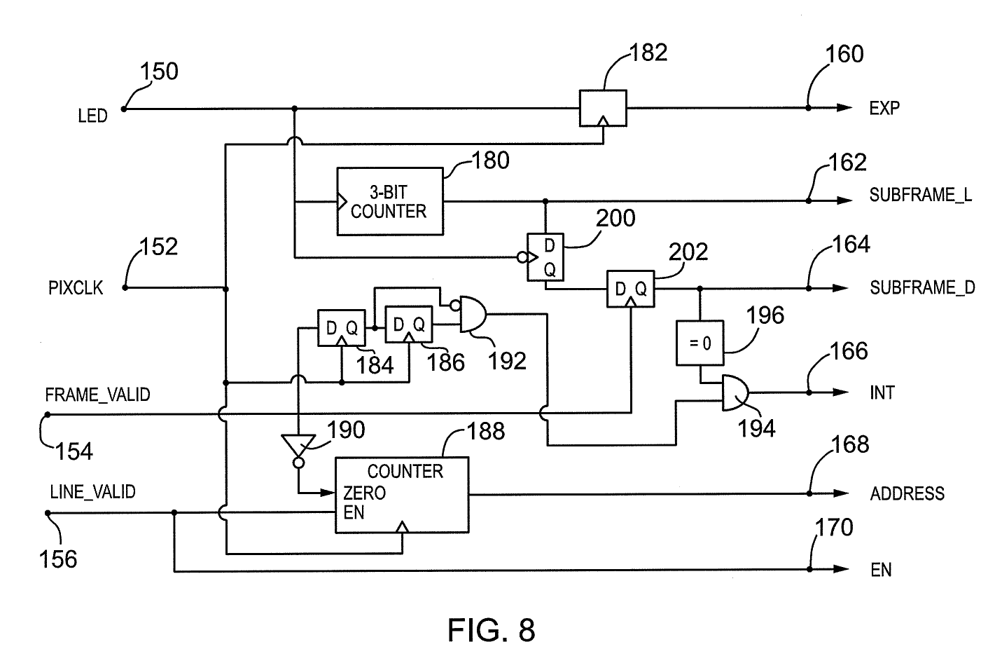

FIG. 8 better illustrates the subframe controller 102. As can be seen, the subframe controller 102 comprises four input terminals 150 to 156 that receive the LED, Frame_Valid, PIXCLK and Line_Valid signal lines extending from the image sensor controller 100. In particular, input terminal 150 receives the LED signal line, input terminal 152 receives the PIXCLK signal line, input terminal 154 receives the Frame_Valid signal line and input terminal 156 receives the Line_Valid signal line. The subframe controller 102 also comprises six output terminals, namely an EXP output terminal 160, a subframe_L output terminal 162, a subframe_D output terminal 164, an INT output terminal 166, an address output terminal 168 and an EN output terminal 170. A three-bit counter 180 has its input connected to the LED input terminal 150 and its output connected to the subframe_L output terminal 162. The input of a latch 182 is also connected to the LED input terminal 150. The output of the latch 182 is coupled to the EXP output terminal 160. The control input of the latch 182 is connected to the PIXCLK input terminal 152. The PIXCLK input terminal 152 is also connected to the control input of a pair of latches 184 and 186 and to the control input of a counter 188. The D input of latch 184 is connected to the zero input of the counter 188 through an inverter 190. The Q input of latch 184 is connected to the inverting input of a gate 192 and to the D input of the latch 186. The Q input of latch 186 is connected to the non-inverting input of the gate 192. The output of the gate 192 is connected to one input of a gate 194. The other input of the gate 194 is connected to the output of a comparator 196. The output of the gate 194 is connected to the INT output terminal 166.

The control input of a latch 200 is also connected to the LED input terminal 150. The D input of the latch 200 is connected to the subframe_L output terminal 162. The Q input of the latch 200 is connected to the D input of a latch 202. The control input of the latch 202 is connected to the Frame_Valid input terminal 154 while its Q input is connected to the subframe_D output terminal 164 and to the input of the comparator 196. The EN input of the counter 188 is connected to the Line_Valid input terminal 156 while the output pin of the counter 188 is connected to the address output terminal 168. The Line_Valid input terminal 156 is also connected directly to the EN output terminal 170.

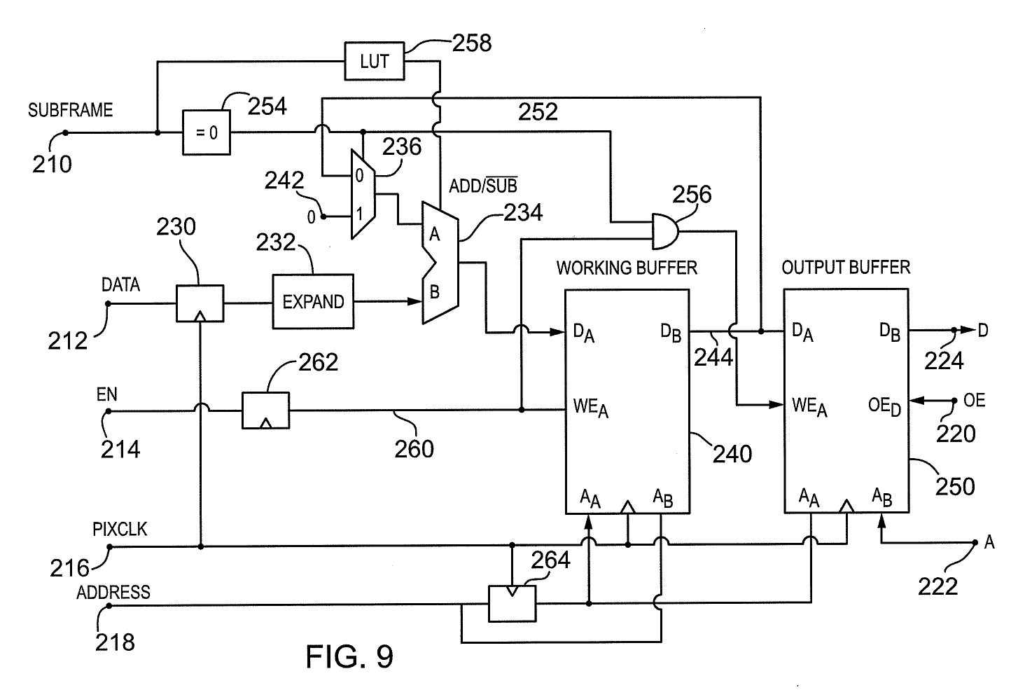

FIG. 9 better illustrates one of the demodulators 104a to 104f. As can be seen, the demodulator comprises seven (7) input terminals 210, namely a subframe input terminal, a data input terminal 212, an EN input terminal 214, a PIXCLK input terminal 216, an address input terminal 218, an OE input terminal 220 and an A input terminal 222. The demodulator also comprises a single D output terminal 224. A latch 230 has its input connected to the data input terminal and its output connected to the input of an expander unit 232. The control input of the latch 230 is connected to the PIXCLK input terminal 216. The output of the expander unit 232 is connected to the B input of an algebraic add/subtract unit 234. The A input of the algebraic unit 234 is connected to the output of a multiplexer 236. The output of the algebraic unit 234 is connected to the D_{A} input of a working buffer 240 in the form of a two-part memory unit. One input of the multiplexer 236 is connected to a null input 242 and the other input pin of the multiplexer 236 is connected to a line 244 extending between the D_{B} input of the working buffer 240 and the D_{A} input of an output buffer 250 in the form of a two-part memory unit. The control input of the multiplexer 236 is connected to a line 252 extending between the output of a comparator 254 and one input of a gate 256. The input of the comparator 254 and the input of a lookup table 258 are connected to the subframe input terminal 210. The output of the lookup table 258 is connected to the control input of the algebraic unit 234. A logic one (1) in the lookup table 258 indicates a Walsh code bit value of “1” and instructs the algebraic unit 234 to perform the add operation. A logic zero (0) in the lookup table 258 indicates a Walsh code bit value of “−1” and instructs the algebraic unit 234 to perform the subtract operation. In this example, the lookup table 258 is programmed with Walsh code W₁:{1,−1,1,−1,1,−1,1,−1} to enable illumination from the bezel segments 40 to 44 to be demodulated, Walsh code W₂:{1,1,−1,−1,1,1,−1,−1} to enable illumination from IR light source 64 to be demodulated and Walsh code W₃:{1,−1,−1,1,1,−1,−1,1} to enable illumination from IR light source 66 demodulated. To enable image frames to be captured that are based on the contribution of all emitted infrared illumination including ambient light, the lookup table 250 is programmed with Walsh code W₀:{1,1,1,1,1,1,1,1}.

The other input of the gate 256 is connected to a line 260 extending between the output of a latch 262 and the WE_{A} input of the working buffer 240. The output of the gate 256 is connected to the WE_{A} input of the output buffer 250. The input of the latch 262 is connected to the EN input terminal 214 and the control input of the latch 262 is connected to the PIXCLK input terminal 216. The PIXCLK input terminal 216 is also connected to the control inputs of the working and output buffers 240 and 250 respectively as well as to the control input of a latch 264. The input of the latch 264 is connected to the address input terminal 218. The output of the latch 264 is connected to the A_{A} inputs of the working and output buffers 240 and 250 respectively. The address input terminal 218 is also connected to the A_{B} input of the working buffer 240. The OE_{B} and A_{B} inputs of the output buffer 250 are connected to the OE and A input terminals 220 and 222 respectively.

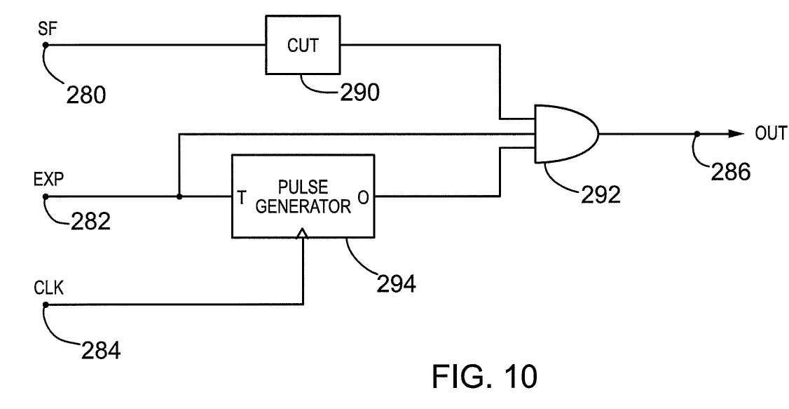

FIG. 10 better illustrates one of the light control interfaces 110 to 114. As can be seen, the light control interface comprises an SF input terminal 280, an EXP input terminal 282 and a CLK input terminal 284. The light control interface also comprises a single output terminal 286. The input of an 8×1 lookup table 290 is connected to the SF input terminal 280. The output of the lookup table 290 is connected to one input of a gate 292. The second input of the gate 292 is connected to the EXP input terminal 282 and the third input of the gate 292 is connected to the Q input of a pulse generator 294. The T input of the pulse generator 294 is connected to the EXP input terminal 282 and the control input of the pulse generator 294 is connect to the CLK input terminal 284. The output of the gate 292 is connected to the output terminal 286. The lookup table 290 stores the state of the Walsh code for each subframe that determines the on/off condition of the associated IR light source during capture of that subframe. Thus, for the illuminated bezel segments 40 to 44, the lookup table 290 of light control interface 110 is programmed with modified Walsh code MW₁={1,0,1,0,1,0,1,0}. For IR light source 64, the lookup table 290 of light control interface 112 is programmed with modified Walsh code MW₂={1,1,0,0,1,1,0,0}. For IR light source 66, the lookup table 290 of the light control interface 114 is programmed with modified Walsh code MW₃={1,0,0,1,1,0,0,1}.

In terms of operation, the demodulators 104a and 104d are programmed to output the image frames from image sensors 60 and 62 that are based substantially only on infrared illumination emitted by the bezel segments 40 to 44. The demodulator 104b is programmed to output the image frame from image sensor 60 based substantially only on infrared illumination emitted by IR light source 64 and the demodulator 104e is programmed to output the image frame from image sensor 62 based substantially only on infrared illumination emitted by IR light source 66. The demodulators 104c and 104f are programmed to output the image frames from image sensors 60 and 62 that are based on the infrared illumination emitted by all of the IR light sources as well as ambient light. These image frames give the microprocessor 80 an unmodulated view of the region of interest allowing the microprocessor to perform exposure control of the image sensors and possibly further object classification.

The light output interfaces 110 to 114 provide output signals to their associated IR light sources following the assigned modified Walsh code MWₓ. As mentioned previously, the Walsh codes are synchronized to the exposure times of the image sensors 60 and 62.

The image sensor controller 100 provides the control signals to and collects the image subframes from each of the image sensors 60 and 62. The clock signal from the crystal oscillator 78 is used to generate the clock signals for both image sensors. The image sensors 60 and 62 are driven so that they expose their image subframes at the same time and deliver the subframe data at the same time. The image sensors in this embodiment provide the subframe data on the CAM1DATA and CAM2DATA data lines respectively, a pixel clock signal on the PIXCLK signal line, a signal that indicates that a subframe is being exposed on the LED signal line, a signal that indicates that a subframe is being clocked out on the FRAME_VALID signal line, and a signal that indicates that the data lines have valid pixel information on the LINE_VALID signal line. The image sensors have a 12-bit resolution (0 to 4095) which is compressed into a 10-bit word (0 to 1023) using a non-linear function or other suitable compression method. The 10-bit data lines are uncompressed prior to demodulation in order to inhibit the resulting non-linear function from destroying the properties of the Walsh codes.

The output interface 106 provides the necessary signals to get the resultant image frames to the microprocessor 80. The form of the output interface is dependent on the type of microprocessor employed and the transfer mode chosen. The internal signal on the INT line is generated by the subframe controller 102 when a new subframe is available in the demodulators 104a to 104f. The output interface 106 enables the output of the first demodulator 104a through the OE₁ signal line. The output interface 106 then sequences through the addresses (A) and reads the data (D) for each pixel, serializes the result, and sends the result to the microprocessor 80. The process is then repeated for the five other demodulators 104b to 104f using the five remaining output enable lines OE₂ to OE₆ until all of the pixel information is transmitted to the microprocessor 80.

The subframe controller 102 is tasked with maintaining synchronization and subframe count. The 3-bit counter 180 outputs the subframe number (0-7) that is currently being exposed by the image sensors 60 and 62 to the light output interfaces 110 to 114 via the subframe_L line. The counter 180 is incremented at the start of every image sensor exposure by the signal on the LED line and wraps around to zero after the last subframe. The data from the image sensors 60 and 62 is not clocked out until sometime after the end of the exposure (the falling edge of LED signal). Latches 300 and 202 delay the subframe count to the next positive edge of the FRAME_VALID signal and this information is sent to the demodulators 104a to 104f to indicate which subframe they are currently processing. The EXP signal is output to the light output interfaces 110 to 114 to allow them to turn their associated IR light sources on. The EXP signal is delayed slightly by latch 182 to ensure that the subframe_L signal line is stable when the IR light sources are activated.

Within each subframe, counter 188 provides a unique address for each pixel. The counter is zeroed at the start of each subframe and incremented whenever a valid pixel is read in. This address is sent to each of the demodulators 104a to 104f along with an enable (EN) that indicates when the CAM1DATA and CAM2DATA data lines are valid.

Valid data is available from the demodulators 104a to 104f at the end of every subframe 0. Latches 184 and 186 and gate 192 provide a single positive pulse at the end of every FRAME_VALID signal. Comparator 196 and gate 194 allow this positive pulse to pass only at the end of subframe 0. This provides the signal on the INT signal line to the output interface 106 indicating that a new resultant image frame is ready to send.

The working buffer 240 is used to store intermediate image frames. New pixels are added or subtracted from the working buffer 240 using the algebraic unit 234 according to the selected Walsh code stored in the lookup table 258.

During subframe 0, image sensor data is transferred directly into the working memory 240. Comparator 254 outputs a logic 1 during subframe 0 which forces multiplexer 236 to force a zero onto the A input of the algebraic unit 234. The output of the lookup table 258 is always a logic 1 during subframe 0 and therefore, the algebraic unit 234 will always add input B to input A (zero), effectively copying input B into the working buffer 240. At each PIXCLK positive edge, the raw data from the image sensor is latched into latch 230, its address is latched into latch 264, and its valid state (EN) is latched into latch 262. As noted above, the data from the image sensor is in a compressed 10-bit form that must be expanded to its original linear 12-bit form before processing. This is done by the expander unit 232. The expander unit 232 also adds an extra three high-order bits to create a 15-bit signed format that inhibits underflow or overflow errors during processing. If the data is valid (output of latch 262 is high) then the expanded data will pass through the algebraic unit 234 unmodified and be latched into the working buffer 240 through its D_{A} input at the pixel address A_{A}. At the end of subframe 0, the entire first subframe is latched into the working buffer 240.

The pixel data in the remaining subframes (1-7) must be either added to or subtracted from the corresponding pixel values in the working buffer 240. While the DATA, ADDRESS, and EN signals are being latched in latches 230, 264, and 262, the current working value of that pixel is latched into the D_{B} input of the working buffer 240. Comparator 254 goes to logic zero in these subframes which causes multiplexer 236 to put the current working value of the pixel to the A input of the algebraic unit 234. The lookup table 258 determines whether the new image data at input B should be added to or subtracted from the current working value according to the Walsh code, where a Walsh code bit of value one (1) represents the add operation and a Walsh code bit of value zero (0) represents the subtract operation. The result is then put back into the same address in the working buffer 240 in the next clock cycle through the D_{A} input.

After processing all eight subframes, the working buffer 240 contains the final resultant image frame. During subframe 0 of the following subframe, this resultant image frame is transferred to the output buffer 250. Since subframe 0 does not use the output from the D_{B} input of working buffer 240, this same port is used to transfer the resultant image frame to the output buffer 250. Gate 256 enables the write-enable input of the A-port (WE_{A}) of the output buffer 250 during subframe zero. The data from the working buffer 240 is then transferred to the output buffer 250 just before being overwritten by the next incoming subframe. The D_{B}, address and output enable O_{B} lines of the output buffer 250 are then used to transfer the resultant image frame through the output interface 106 to the microprocessor 80.

Just before the exposure signal (EXP) goes high, the subframe controller 102 sets the current subframe that is being exposed (SF). If the lookup table 290 outputs a zero (0), then gate 292 keeps the associated IR light source off for this subframe. If the lookup table outputs a one (1), then the associated IR light source is switched on. The on duration is determined by the pulse generator 294. The pulse generator 294 starting with trigger (T), outputs a positive pulse a given number of clock cycles (in this case the pixel clock) long. At the end of the pulse, or when the image sensor exposure time is done, the gate 292 switches off the associated IR light source.

The pulse generators 294 allow the influence of each IR light source to be dynamically adjusted independently of the other light sources and of the sensor integration time to get the optimum balance. With the pulse time in each IR light source held constant, the exposure time of the image sensors 60 and 62 can be adjusted to get the best ambient light images (demodulators 104c and 104f) without affecting the modulated image frames (demodulators 104a, 104b, 104d, and 104e). The smallest possible integration time of the image sensors is equal to the longest pulse time of the three IR light sources. The largest possible integration time of the image sensors is the point where the pixels start to saturate, in which case the demodulation scheme will experience a failure.

In the embodiment described above, Walsh codes are employed to modulate and demodulate the IR light sources. Those of skill in the art will appreciate that other digital codes may be employed to modulate and demodulate the IR light sources such as for example, those used in OOK, FSK, ASK, PSK, QAM, MSK, CPM, PPM, TCM, OFDM, FHSS or DSSS communication systems.

Although the image sensors are shown as being positioned adjacent the bottom corners of the display surface, those of skill in the art will appreciate that the image sensors may be located at different positions relative to the display surface. The tool tray segment need not be included and if desired may be replaced with an illuminated bezel segment. Also, although the illuminated bezel segments 40 to 44 and light sources 64 and 66 are described as IR light sources, those of skill in the art will appreciate that other suitable radiation sources may be employed.

Although the interactive input system 20 is described as detecting a pen tool having a retro-reflective or highly reflective tip, those of skill in the art will appreciate that the interactive input system can also detect active pointers that emit signals when in proximity to the display surface 24. For example, the interactive input system may detect active pen tools that emit infrared radiation such as that described in U.S. patent application Ser. No. ______ to Bolt et al. entitled “Interactive Input System And Pen Tool Therefor” filed concurrently herewith and assigned to SMART Technologies ULC of Calgary, Alberta, the content of which is incorporated by reference.

In this embodiment, when an active pen tool is brought into proximity with the display surface 24, the active pen tool emits a modulated signal having components at frequencies equal to 120 Hz, 240 Hz and 360 Hz. These frequencies are selected as the Walsh codes have spectral nulls at these frequencies. As a result, the modulated light output by the active pen tool is filtered out during processing to detect the existence of the active pen tool in the region of interest and therefore, does not impact pointer detection. When the existence of a pointer is detected, the microprocessor 80 subjects the image frame based on the infrared illumination emitted by all of the IR light sources as well as ambient light, to a Fourier transform resulting in the dc bias and the 480 Hz component of the image frame representing the contribution from the illuminated bezel segments being removed. The microprocessor 80 then examines the resulting image frame to determine if any significant component of the resulting image frame at 120 Hz, 240 Hz and 360 Hz exists. If so, the signal pattern at these frequencies is used by the microprocessor 80 to identify the active pen tool.

As will be appreciated, as the modulated signal emitted by the active pen tool can be used by the microprocessor 80 to identify the active pen tool, detection of multiple active pen tools in proximity of the display surface 24 is facilitated. If during pointer detection, two or more dark regions interrupting the bright band are detected, the modulated light output by the active pen tools can be processed separately to determine if the modulated signal components at frequencies equal to 120 Hz, 240 Hz and 360 Hz thereby to allow the individual active pen tools to be identified. This inhibits modulated signals output by the active pen tools from interfering with one another and enables each active pen tool to be associated with the image presented on the display surface 24 allowing active pen tool input to be processed correctly.

The interactive input system may of course take other forms. For example, the illuminated bezel segments may be replaced with retro-reflective or highly reflective bezels as described in the above-incorporated Bolt et al. application. Those of skill in the art will however appreciate that the radiation modulating technique may be applied to basically any interaction input system that comprises multiple radiation sources to reduce interference and allow information associated with each radiation source to be separated.

Although embodiments have been described with reference to the drawings, those of skill in the art will appreciate that variations and modifications may be made without departing from the spirit and scope thereof as defined by the appended claims.

What is claimed is:

1. An interactive input system comprising:
at least one imaging device capturing images of a region of interest;
a plurality of radiation sources, each providing illumination to said region of interest; and
a controller coordinating the operation of said radiation sources and said at least one imaging device to allow separate image frames based on contributions from different radiation sources to be generated.

2. An interactive input system according to claim 1 wherein each radiation source is switched on and off according to a distinct switching pattern.

3. An interactive input system according to claim 2 wherein the distinct switching patterns are substantially orthogonal.

4. An interactive input system according to claim 2 wherein the distinct switching patterns and imaging device frame rate are selected to eliminate substantially effects from ambient light and flickering light sources.

5. An interactive input system according to claim 4 wherein said distinct switching patterns follow Walsh codes.

6. An interactive input system according to claim 3 wherein said plurality of radiation sources comprises at least three radiation sources.

7. An interactive input system according to claim 3 wherein at least one of said radiation sources backlights a pointer positioned within said region of interest.

8. An interactive input system according to claim 3 wherein at least one of said radiation sources front lights a pointer positioned within said region of interest.

9. An interactive input system according to claim 8 wherein two of said radiation sources front light a pointer positioned within the region of interest.

10. An interactive input system according to claim 4 comprising at least two imaging devices capturing images of the region of interest from different vantages, and a radiation source associated with each imaging device.

11. An interactive input system according to claim 10 wherein each radiation source is positioned proximate said respective imaging device.

12. An interactive input system according to claim 7 wherein said radiation source that backlights a pointer positioned within said region of interest is an illuminated bezel about said region of interest.

13. An interactive input system according to claim 12 wherein said region of interest is polygonal and wherein said illuminated bezel extends along multiple sides of said region of interest.

14. An interactive input system according to claim 13 wherein said region of interest is generally rectangular, said illuminated bezel extends along at least three sides of said region of interest, imaging devices being positioned adjacent opposite corners of said region of interest.

15. An interactive input system according to claim 4 wherein said radiation sources emit one of infrared and visible radiation.

16. An interactive input system according to claim 1 further comprising processing structure processing the separated image frames to determine the location of a pointer within the region of interest.

17. An interactive input system according to claim 16 wherein each radiation source is switched on and off according to a distinct switching pattern.

18. An interactive input system according to claim 17 wherein the distinct switching patterns are substantially orthogonal.

19. An interactive input system according to claim 17 wherein the distinct switching patterns and imaging device frame rate are selected to eliminate substantially effects from ambient light and flickering light sources.

20. An interactive input system according to claim 19 wherein said distinct switching patterns follow Walsh codes.

21. An interactive input system according to claim 17 wherein at least one of said radiation sources backlights a pointer positioned within said region of interest.

22. An interactive input system according to claim 17 wherein at least one of said radiation sources front lights a pointer positioned within said region of interest.

23. An interactive input system according to claim 19 comprising at least two imaging devices capturing images of the region of interest from different vantages, and a radiation source associated with each imaging device.

24. An interactive input system according to claim 23 wherein each radiation source is positioned proximate said respective imaging device.

25. An interactive input system according to claim 21 wherein said radiation source that backlights a pointer positioned within said region of interest is an illuminated bezel about said region of interest.

26. An interactive input system according to claim 25 wherein said region of interest is polygonal and wherein said illuminated bezel extends along multiple sides of said region of interest.

27. An interactive input system according to claim 26 wherein said region of interest is generally rectangular, said illuminated bezel extends along at least three sides of said region of interest, imaging devices being positioned adjacent opposite corners of said region of interest.

28. An interactive input system according to claim 17 wherein said radiation sources emit infrared radiation.

29. An interactive input system comprising:
at least two imaging devices capturing overlapping images of a region of interest from different vantages;
a radiation source associated with each imaging device to provide illumination into the region of interest;
a controller timing the frame rates of the imaging devices with distinct switching patterns assigned to the radiation sources and demodulating captured image frames to generate image frames based on contributions from different radiation sources; and
processing structure processing the separated image frames to determine the location of a pointer within the region of interest.

30. An interactive input system according to claim 29 wherein the distinct switching patterns are substantially orthogonal.

31. An interactive input system according to claim 29 wherein the distinct switching patterns and imaging device frame rates are selected to eliminate substantially effects from ambient light and flickering light sources.

32. An interactive input system according to claim 31 wherein said distinct switching patterns follow Walsh codes.

33. An interactive input system according to claim 29 wherein said radiation sources emit one of infrared and visible radiation.

34. An interactive input system according to claim 29 further comprising a backlight radiation source at least partially surrounding said region of interest.

35. An interactive input system according to claim 34 wherein the distinct switching patterns and imaging device frame rates are selected to eliminate substantially effects from ambient light and flickering light sources.

36. An interactive input system according to claim 35 wherein the distinct switching patterns are substantially orthogonal.

37. An interactive input system according to claim 36 wherein said distinct switching patterns follow Walsh codes.

38. An interactive input system according to claim 29 further comprising a reflective bezel at least partially surrounding said region of interest.

39. An interactive input system according to claim 38 wherein the distinct switching patterns and imaging device frame rates are selected to eliminate substantially effects from ambient light and flickering light sources.

40. An interactive input system according to claim 39 wherein the distinct switching patterns are substantially orthogonal.

41. An interactive input system according to claim 40 wherein said distinct switching patterns follow Walsh codes.

42. An interactive input system according to claim 38 wherein said reflective bezel comprises retro-reflective material.

43. An interactive input system according to claim 42 wherein the distinct switching patterns and imaging device frame rates are selected to eliminate substantially effects from ambient light and flickering light sources.

44. An interactive input system according to claim 43 wherein the distinct switching patterns are substantially orthogonal.

45. An interactive input system according to claim 44 wherein said distinct switching patterns follow Walsh codes.

46. A method of generating image frames in an interactive input system comprising at least one imaging device capturing images of a region of interest and multiple radiation sources providing illumination into the region of interest, said method comprising:
turning each radiation source on and off according to a distinct pattern, the patterns being generally orthogonal;
synchronizing the frame rate of the imaging device with the distinct patterns; and
demodulating the captured image frames to yield image frames based on contributions from different radiation sources.

47. In an interactive input system comprising at least one imaging device capturing images of a region of interest and multiple radiation sources providing illumination into the region of interest, an imaging method comprising:
modulating the output of said radiation sources;
synchronizing the frame rate of the imaging device with the modulated radiation source output; and
demodulating captured image frames to yield image frames based on contributions from different radiation sources.
